(19) United States
(12) Patent Application Publication
(10) Pub. No.: US 2008/0019321 A1
(43) Pub. Date: Jan. 24, 2008

(54) MULTI-HOP RELAY SYSTEM AND DATA TRANSMISSION METHOD EMPLOYED BY THE SAME

(75) Inventors: Juhee KIM, Daejeon-city (KR); Kyung Soo KIM, Daejeon-city (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon-city (KR)

(21) Appl. No.: 11/780,019

(22) Filed: Jul. 19, 2007

(30) Foreign Application Priority Data
Jul. 19, 2006 (KR) 10-2006-0067345
Jul. 19, 2007 (KR) 10-2007-0072157

(51) Int. Cl. H04Q 7/00

(52) U.S. Cl. 370/332

(57) ABSTRACT

Provided are a multi-hop relay system and a data transmission method employed by the multi-hop relay system. In multi-hop relay system, a relay station measures quality measurement information of fast feedback channels between the relay stations and two or more mobile stations and transmitting the quality measurement information of fast feedback channels, a base station determines whether to transmit data via the relay stations based on the quality measurement information received from the relay stations.

### CROSS-REFERENCE TO RELATED PATENT APPLICATION

This application claims the benefit of Korean Patent Application No. 10-2006-0067345, filed on Jul. 19, 2006 and Korean Patent Application No. 10-2007-0072157, filed on Jul. 19, 2007 in the Korean Intellectual Property Office, the disclosures of which are incorporated herein in their entirety by reference.

### BACKGROUND OF THE INVENTION

1. Field of the Invention

The present invention relates to a multi-hop relay system, and more particularly to, a multi-hop relay system and method of determining data transmission via a relay station (RS) in the multi-hop relay system.

The present invention is derived from a study made by the Ministry of Information and Communication (MIC) of the Republic of Korea and the Institute for Information Technology Advancement (IITA) as one of new growth engine core IT technology development projects (assignment number: 2006-S-011-01; assignment name: Relay/Mesh Communication System for Multi-hop WiBro).

2. Description of the Related Art

An Institute of Electrical and Electronics Engineers (IEEE) 802.16-based wireless portable Internet system is a 3.5 generation mobile communication system providing various types of IP-based wireless data images (streaming video, file transfer protocol (FTP), mail, chatting, or the like) and fast packet data transmission by using a wireless transmission technology that guarantees spectrum efficiency at a 2.3 GHz frequency band, based on the IEEE 802.16 Wireless Metropolitan Area Network (MAN) standard that is being developed by the IEEE 802.16 Working Group.

In the IEEE 802.16 Wireless MAN standard, which is currently being developed by the IEEE 802.16j Mobile Multi-hop Relay (MMR) Working Group, a relay station (RS) having a high level function is introduced to extend coverage range and enhance capacity of IEEE 802.16 systems.

The coverage range extension aims at supporting a cell boundary and cell range in the same manner as a conventional wireless communication system uses the RS. The capacity enhancement aims at supporting a data speed faster than achieved by a direct link between a base station (BS) and a mobile station (MS) by using the RS that functions between the BS and the MS.

In order to extend coverage range and enhance capacity, the IEEE 802.16j MMR Working Group is developing to support additional functions of a physical layer protocol (PHY) and a limited media access control (MAC) and a conventional RS function of analog or digital amplification of a radio frequency (RF) signal as well. Thus, it is necessary to specify a relay control protocol between BS, RS, and MS in order to determine whether the MS uses the RS to relay data. An efficient data relay control protocol can result in an increase in overall system yield and a user service speed as well.

### SUMMARY OF THE INVENTION

The present invention provides a multi-hop relay system for increasing system and user efficiency owing to the efficient use of a relay station (RS) and a data transmission method employed by the multi-hop relay system.

According to an aspect of the present invention, there is provided a data transmission method employed by a multi-hop relay system comprising a base station, one or more relay stations in a cell of the base station, and one or more mobile stations connected to the relay stations, the method for the base station comprising: receiving quality measurement information of fast feedback channels between the relay stations and the mobile stations on a regular basis; and determining whether to transmit data via the relay stations based on the quality measurement information.

According to another aspect of the present invention, there is provided a multi-hop relay system comprising: a relay station measuring quality measurement information of fast feedback channels between the relay stations and two or more mobile stations and transmitting the quality measurement information of fast feedback channels; and a base station determining whether to transmit data via the relay stations based on the quality measurement information received from the relay stations.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates the IEEE 802.16 Wireless Metropolitan Area Network (MAN) system supporting a mobile multi-hop relay (MMR) according to an embodiment of the present invention;

FIG. 2 is a schematic structure of a wireless portable Internet system and a flowchart illustrating a data transmission method using a relay station (RS) for improving data transmission yield according to an embodiment of the present invention;

FIG. 3 is a schematic structure of a wireless portable Internet system and a flowchart illustrating a data transmission method using an RS for extending coverage range according to an embodiment of the present invention; and

FIG. 4 is a diagram of an SEARCH-REQ message according to an embodiment of the present invention.

### DETAILED DESCRIPTION OF THE INVENTION

The present invention will be described in detail by explaining preferred embodiments of the invention with reference to the attached drawings.

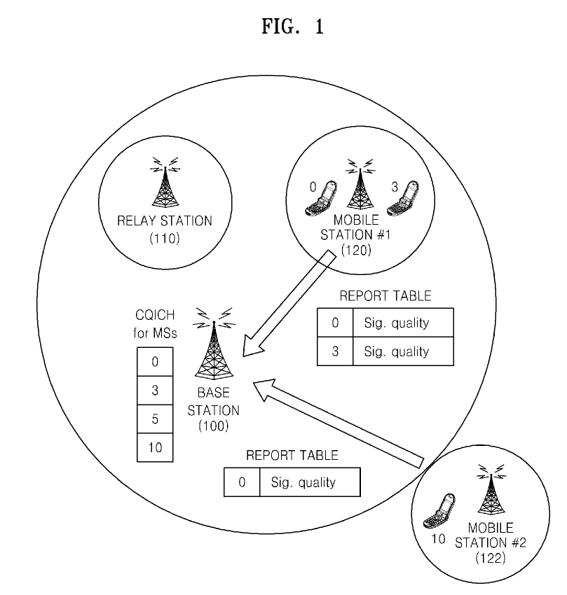

FIG. 1 illustrates an IEEE 802.16 Wireless Metropolitan Area Network (MAN) system supporting a mobile multi-hop relay (MMR) according to an embodiment of the present invention. Referring to FIG. 1, the IEEE 802.16 Wireless MAN system using a relay station (RS) 110 includes mobile stations (MS) 120 and 122, a base station (BS) 100 that wirelessly communicates data with the MSs 120 and 122, and the RS 110 that relays data that is transmitted from the BS 100 to the MSs 120 and 122.

The BS 100 transmits the data to the MSs 120 and 122 directly or via the RS 110. When the BS 100 transmits the data to the MSs 120 and 122 via the RS 110, the BS 100 transmits the data to the RS 110, and the RS 110 reprocesses the data and transmits the reprocessed data to the MSs 120 and 122. A data burst between the BS 100 and the RS 110 determines a modulation and coding scheme (MCS) using channel measurement information between the BS 100 and the RS 110. A data burst between the RS 110 and the MSs 120 and 122 determines the MCS using channel measurement information on channel quality indicator channels (CQICHs) that are fast feedback channels.

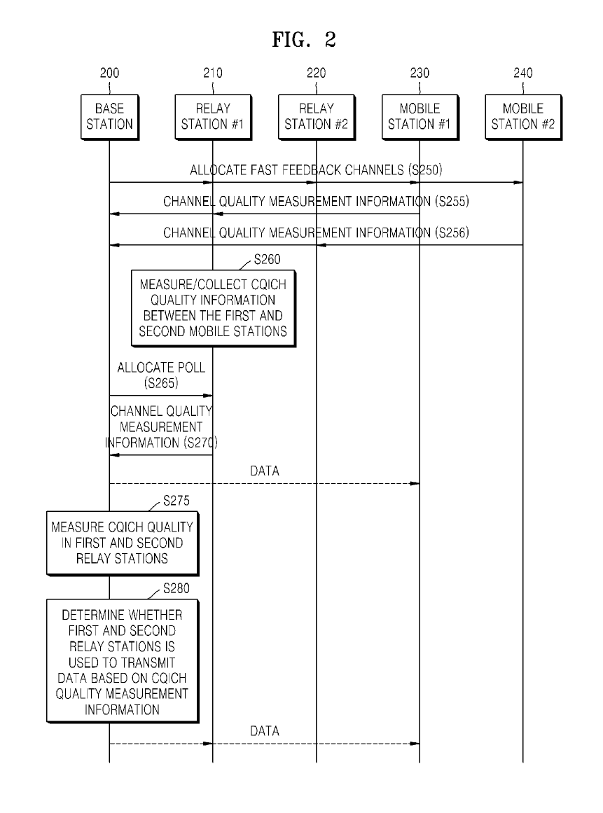

FIG. 2 is a schematic structure of a wireless portable Internet system and a flowchart illustrating a data transmission method using an RS for improving data transmission yield according to an embodiment of the present invention. Referring to FIG. 2, if first and second MSs 230 and 240 are registered in a cell, a BS 200 allocates the CQICHs to the first and second MSs 230 and 240 in order to obtain channel information between the BS 200 and the first and second MSs 230 and 240 for data transmission and upstream wireless resource allocation (Operation 250). In this regard, the first and second MSs 230 and 240 are connected to first and second RSs 210 and 220, respectively.

The first and second MSs 230 and 240 transmit channel quality measurement information of a wireless frame to the BS 200 through the CQICHs on a regular basis (Operations 255 and 256). The BS 200 performs scheduling using the channel quality measurement information, and determines the MCS in a physical layer when transmitting downstream data. The CQICH quality measurement information is transmitted to the first and second RSs 210 and 220 and the BS 200 as well. The first and second RSs 210 and 220 measure and collect the CQICH quality information between the first and second MSs 230 and 240 (Operation 260).

The BS 200 regularly provides a poll in order to report a channel measurement result to the first and second RSs 210 and 220 (Operation 265). The first RS 210 to which the upstream wireless resource is allocated transmits a measurement report message including a table containing the CQICH quality measurement information that is transmitted from the first MS 230 to the BS 200 (Operation 270). The table contains a CQICH index that is MS identification information and the CQICH quality measurement information (e.g., a signal to noise ratio (SNR), a carrier to interference noise ratio (CINR) or the like).

The first RS 210 does not include all channels of which quality is measured in the table. An MS having a CQICH quality value greater than a basic threshold among channel measurement values is included in the table. The basic threshold is provided from a BS to an RS through a cell broadcast message or a notice message.

The BS 200 that receives the channel report message determines whether a relevant RS is used to transmit data based on CQICH quality measurement information M_{BS,i} that is measured in the BS 200, CQICH quality measurement information M_{RS,i} that is measured in the first RS 210, and CQICH quality measurement information M_{BS,RS} where RS is between the BS 200 and the first RS 210 that is measured in the BS 200 (Operations 275 and 280). Equation 1 below is used to determine whether to relay the data.

| if M _{BS, I} < M _{BS,RS} + M _{RS, i} | |
|---|---|
| BS transmits data to i^{th} MS via RS | |
| else BS directly transmits data to i^{th} MS | ...................... (1) |

If the BS 200 determines that the data is transmitted via the first RS 210, the BS 200 transmits the data to the first MS 230 via the first RS 210 from a subsequent frame. If a wireless channel status is contrary to Equation 1, the BS 200 directly transmits the data to the first MS 230.

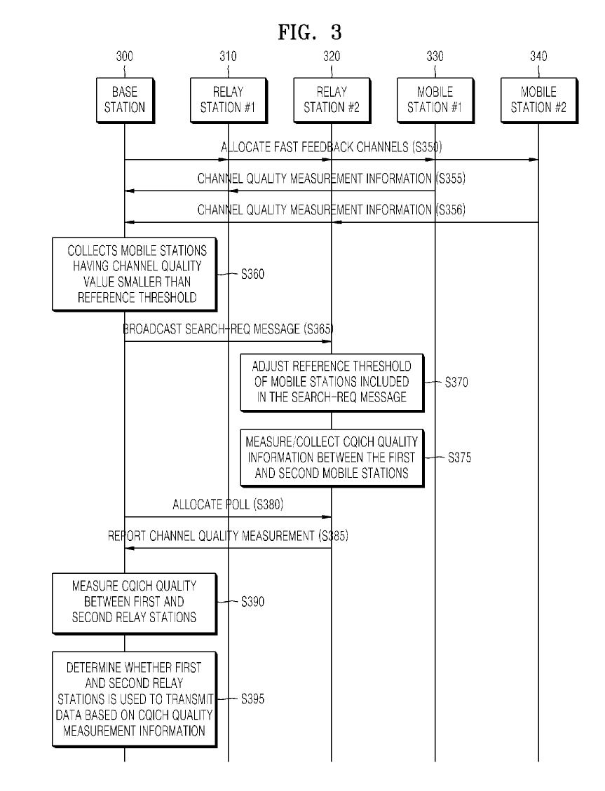

FIG. 3 is a schematic structure of a wireless portable Internet system and a flowchart illustrating a data transmission method using an RS for extending a coverage range according to an embodiment of the present invention. Referring to FIG. 3, if first and second MSs 330 and 340 are registered in a cell, a BS 300 allocates the CQICH to the first and second MSs 330 and 340 in order to obtain channel quality information between the BS 300 and the first and second MSs 330 and 340 for data transmission and upstream wireless resource allocation (Operation 350). In this regard, the first and second MSs 330 and 340 are connected to first and second RSs 310 and 320, respectively.

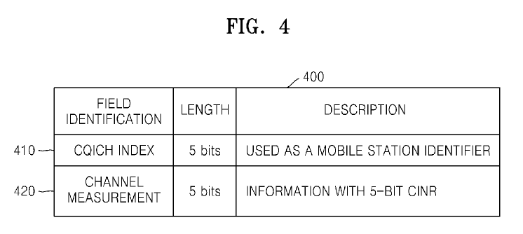

The BS 300 collects MSs having a channel quality value smaller than a previously set reference threshold based on the CQICH quality measurement result that is transmitted from the first and second MSs 330 and 340 (Operation 360). The BS 300 broadcasts a SEARCH-REQ message including a CQICH index that is used to identify the collected MSs (Operation 365). An example of the SEARCH-REQ message is shown in FIG. 4.

The first and second RSs 310 and 320 in a cell receive the SEARCH-REQ message that is broadcasted from the BS 300, and store CQICHs corresponding to the MSs included in the SEARCH-REQ message in a channel measurement information message that is reported to the BS 300 irrespective of the reference threshold. In more detail, the first and second RSs 310 and 320 lowers the reference threshold of the MSs included in the SEARCH-REQ message (Operation 370) in order to report a quality measurement result of CQICHs corresponding to the MSs included in the SEARCH-REQ message to the BS 300 (Operations 380 and 385). Operations 380 and 385 of allocating a poll on a regular basis and reporting the wireless channel measurement result are the same as described with reference to FIG. 2.

Furthermore, if a wireless channel status is contrary to Equation 1, direct data transmission between the BS 300 to the first MS 330 is the same as described with reference to FIG. 2.

If the BS 300 determines that the data is transmitted via an RS (Operations 390 and 395) according to the same process as shown in FIG. 2, the BS 300 transmits the data to the second MS 340 via the second RS 320 from subsequent data.

FIG. 4 is a diagram of a SEARCH-REQ message according to an embodiment of the present invention. Referring to FIG. 4, the SEARCH-REQ message 400 comprises a CQICH index field 410 and a channel measurement field 420. The CQICH index field 410 includes MS identification information. The channel measurement field 420 includes information on a 5-bit CINR.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

The present invention provides a signal protocol between an RS and an MS necessary for determining whether to transmit data to an MS via a relay of the BS and the RS in the IEEE 802.16-based wireless portable Internet system, and a method of operating the signal protocol, thereby more easily transmitting data via the relay, and improving system and user yield.

While this invention has been particularly shown and described with reference to preferred embodiments thereof, it will be understood by those of ordinary skill in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A data transmission method employed by a multi-hop relay system comprising a base station, one or more relay stations in a cell of the base station, and one or more mobile stations connected to the relay stations, the method for the base station comprising:
receiving quality measurement information of fast feedback channels between the relay stations and the mobile stations on a regular basis; and
determining whether to transmit data via the relay stations based on the quality measurement information.

2. The method of claim 1, wherein the fast feedback channels are channel quality indicator channels (CQICHs).

3. The method of claim 1, wherein the quality measurement information comprises information for identifying the mobile stations.

4. The method of claim 1, wherein the receiving of the quality measurement information comprises:
allocating a poll to the relay stations on a regular basis; and
receiving the quality measurement information of a fast feedback channel having a quality value greater than a previously set threshold among the quality measurement information of fast feedback channels between the relay stations and the mobile stations, which is measured in the relay stations.

5. The method of claim 1, wherein, in the determining whether to transmit data via the relay stations, based on first quality measurement information between the base station and the mobile stations, which is measured in the base station, second quality measurement information between the relay stations and the mobile stations, which is measured in the relay stations, and third quality measurement information between the base station and the relay stations, which is measured in the base station, if a value of the first quality measurement information is smaller than the sum of values of the second and third quality measurement information, it is determined that the data is transmitted via the relay stations.

6. The method of claim 1, further comprising:
broadcasting a message containing information on the mobile stations having a channel quality value smaller than the previously set threshold based on the quality measurement information of fast feedback channels between the relay stations and the mobile stations,
wherein the receiving of the quality measurement information further comprises: receiving quality measurement information of fast feedback channels between the mobile stations included in the message and the relay stations.

7. The method of claim 6, wherein the message comprises information for identifying the mobile stations having a channel quality value smaller than the previously set threshold and channel quality measurement information.

8. A multi-hop relay system comprising:
a relay station measuring quality measurement information of fast feedback channels between the relay stations and two or more mobile stations and transmitting the quality measurement information of fast feedback channels; and
a base station determining whether to transmit data via the relay stations based on the quality measurement information received from the relay stations.

9. The system of claim 8, wherein the fast feedback channels are channel quality indicator channels (CQICHs).

10. The system of claim 8, wherein the quality measurement information comprises information for identifying the mobile stations.

11. The system of claim 8, wherein the base station allocates a poll to the relay stations on a regular basis; and
the relay stations to which the poll is allocated transmits the quality measurement information of a fast feedback channel having a quality value greater than a previously set threshold, to the base station, among the quality measurement information of fast feedback channels between the relay stations and the mobile stations.

12. The system of claim 8, wherein based on first quality measurement information between the base station and the mobile stations that is measured in the base station, second quality measurement information between the relay stations and the mobile stations, which is measured in the relay stations, and third quality measurement information between the base station and the relay stations, which is measured in the base station, if a value of the first quality measurement information is smaller than the sum of values of the second and third quality measurement information, the base station determines that data is transmitted via the relay stations.

13. The system of claim 8, wherein the base station broadcasts a message containing information on the mobile stations having a channel quality value smaller than the previously set threshold based on the quality measurement information of fast feedback channels between the relay stations and the mobile stations,
wherein the relay stations lower a reference threshold of the mobile stations included in the message, and transmits quality measurement information of a fast feedback channel having a quality value greater than the reference threshold to the base station based on the quality measurement information of fast feedback channels between the relay stations and the mobile stations.

14. The system of claim 13, wherein the message comprises information for identifying the mobile stations having the channel quality value smaller than the previously set threshold and channel quality measurement information.

15. A computer readable recording medium storing a computer readable program for executing the method of claim 1.
